(19) United States
(12) Patent Application Publication
(10) Pub. No.: US 2024/0422632 A1
(43) Pub. Date: Dec. 19, 2024

(54) METHOD AND APPARATUS FOR DETERMINING FAILURE TYPE

(71) Applicant: LENOVO (BEIJING) LIMITED, Beijing (CN)

(72) Inventors: Le YAN, Shanghai (CN); Mingzeng DAI, Shanghai (CN); Lianhai WU, Beijing (CN); Congchi ZHANG, Shanghai (CN)

(21) Appl. No.: 18/262,869

(22) PCT Filed: Jan. 25, 2021
(86) PCT No.: PCT/CN2021/073584

§ 371 Date: Jul. 25, 2023

(51) Int. Cl. H04W 36/00; H04W 24/04; H04W 24/10; H04W 76/19

(52) U.S. Cl. CPC H04W 36/0079; H04W 24/04; H04W 24/10; H04W 76/19

(57) ABSTRACT

The present application relates to a method and an apparatus for determining a failure type. One embodiment of the present disclosure provides a method performed by a user equipment (UE), which includes: performing a first listen before talk (LBT) procedure before transmitting an access message for a handover procedure; determining first LBT information and/or first handover failure (HOF) information when a HOF occurs; and transmitting the first LBT information and/or the first HOF information to a serving node of the UE.

### TECHNICAL FIELD

The present disclosure relates to wireless communications, more specifically, the present disclosure relates to a method and an apparatus for determining a failure type.

### BACKGROUND OF THE INVENTION

In new radio unlicensed spectrum (NR-U), base stations (BSs) and user equipment (UE) may operate in both licensed and unlicensed spectrum. In order to achieve fair coexistence with other wireless systems, a channel access procedure, for example, listen before talk (LBT), is required before the BS or the UE starts the transmission on unlicensed spectrum. Only when the LBT is successful, the BS or the UE can start the transmission on the channel and occupy the channel up to a maximum channel occupancy time (MCOT); otherwise, the BS or the UE can't start the transmission and may continue to performing LBT until the LBT is successful.

During a handover process, the handover may fail due to many causes including a LBT failure. Therefore, it is desirable to provide a solution to handle the handover failure brought by the LBT failure.

### SUMMARY

One embodiment of the present disclosure provides a method performed by a user equipment (UE), which includes: performing a first listen before talk (LBT) procedure before transmitting an access message for a handover procedure; determining first LBT information and/or first handover failure (HOF) information when a HOF occurs; and transmitting the first LBT information and/or the first HOF information to a serving node of the UE.

In one embodiment of the present disclosure, the method further includes storing the first HOF information if a first measurement result associated with a target cell when a first timer expires is lower than a first predefined value, and/or a second measurement result associated with a source cell when the first timer expires is higher than a second predefined value; and not storing the first HOF information if the first measurement result is higher than the first predefined value, and/or the second measurement result is lower than the second predefined value;

In one embodiment of the present disclosure, the first LBT information includes at least one of the following: a cause for the HOF; a total number of a first type of LBT failure indicated by a first indication when a first timer is running; a total number of uplink (UL) bandwidth parts (BWP) in the target cell associated with a LBT failure detection and recovery procedure when the first timer is running; a second indication; a time point of when the second indication is triggered; a maximum value of the first type of LBT failure for each BWP; a maximum value of a second timer associated with a second type of LBT failure for each BWP; one or more physical random access channel (PRACH) occasions for each BWP; a first time period in the UE for the LBT failure detection and recovery procedure in each BWP of the target cell; a second time period from a time point when the handover procedure is initialized to a time point when the second indication is received; a third time period from a time point when the second indication is received to a time point when the handover procedure fails; a third measurement result associated with the target cell when a second type of LBT failure occurs in a BWP in the target cell; a fourth measurement result associated with a target cell when a third type of LBT failure occurs; a fifth measurement result associated with a source cell when the second type of LBT failure occurs in a BWP in the source cell; and a sixth measurement result associated with the source cell when the third type of LBT failure occurs.

In one embodiment of the present disclosure, the first LBT information and the first HOF information are transmitted in a same message or in different messages.

In one embodiment of the present disclosure, the method further includes optimizing LBT configuration.

Another embodiment of the present disclosure provides a method performed by a source node, comprising: receiving first listen before talk (LBT) information and/or first handover failure (HOF) information from a user equipment (UE) or from a serving node, or receiving second LBT information from a target node and/or second HOF information from a serving node; and determining a failure type based on the first LBT information and/or the first HOF information, or determining a failure type based on the second LBT information and/or the second HOF information.

In one embodiment of the present disclosure, the failure type is inappropriate mobility configuration and/or inappropriate LBT configuration.

In one embodiment of the present disclosure, the method further includes transmitting a first message to the target node for optimizing LBT configuration when the failure type is inappropriate LBT configuration.

In one embodiment of the present disclosure, the first LBT information includes at least one of the following: a cause for the HOF; a total number of a first type of LBT failure indicated by a first indication when a first timer is running; a total number of uplink (UL) bandwidth parts (BWP) in the target cell associated with a LBT failure detection and recovery procedure when the first timer is running; a second indication; a time point of when the second indication is triggered; a maximum value of the first type of LBT failure for each BWP; a maximum value of a second timer associated with a second type of LBT failure for each BWP; one or more physical random access channel (PRACH) occasions for each BWP; a first time period in the UE for the LBT failure detection and recovery procedure in each UL BWP of the target cell; a second time period from a time point when the handover procedure is initialized to a time point when the second indication is received; a third time period from a time point when the second indication is received to a time point when the handover procedure fails; a third measurement result associated with the target cell when a second type of LBT failure occurs in a BWP in the target cell; a fourth measurement result associated with a target cell when a third type of LBT failure occurs; a fifth measurement result associated with a source cell when the second type of LBT failure occurs in a BWP in the source cell; and a sixth measurement result associated with the source cell when the third type of LBT failure occurs.

In one embodiment of the present disclosure, the second LBT information includes at least one of the following: a cause for the HOF; a first indication; a second indication; a number of a first type of LBT failure indicated by the first indication for a downlink (DL) bandwidth part (BWP) since receiving an access message from the UE; a total number of the first indication since receiving the access message from the UE; a total number of DL BWPs associated with a LBT failure detection and recovery procedure in the target cell since receiving the access message from the UE; a time point of when the first indication or the second indication is triggered; a maximum value of the first type of LBT failure for each BWP; a maximum value of a second timer associated with a second type of LBT failure for each BWP; one or more physical random access channel (PRACH) occasions for each BWP; and a first time period for the LBT failure detection and recovery procedure in each BWP of the target cell.

Another embodiment of the present disclosure provides a method performed by a source node, comprising: determining third listen before talk (LBT) information when a radio link failure (RLF) occurs due to a LBT failure before a handover command is transmitted; and/or receiving first RLF information from a serving node; determining a failure type based on the third LBT information, and/or the first RLF information; and optimizing LBT configuration.

In one embodiment of the present disclosure, the method further includes optimizing the LBT configuration when a source cell quality at the time point that a radio link failure (RLF) occurs in the source cell is higher than a second predefined threshold.

Another embodiment of the present disclosure provides a method performed by a target node, comprising: performing a second listen before talk (LBT) procedure after receiving an access message from a user equipment (UE); determining second LBT information when the second LBT procedure fails; and transmitting the second LBT information to a source node.

In one embodiment of the present disclosure, the method further includes optimizing LBT configuration.

In one embodiment of the present disclosure, the method further includes optimizing LBT configuration when a target cell quality is higher than a threshold when the second LBT procedure fails.

In one embodiment of the present disclosure, the method further includes receiving a first message for optimizing LBT configuration from the source node.

In one embodiment of the present disclosure, the second LBT information includes at least one of the following: a cause for the HOF; a first indication; a second indication; a number of a first type of LBT failure indicated by a first indication for a downlink (DL) bandwidth part (BWP) since receiving an access message from the UE; a total number of the first indication since receiving the access message from the UE; a total number of DL BWPs associated with a LBT failure detection and recovery procedure in the target cell since receiving the access message from the UE; a time point of when the first indication or the second indication is triggered; a maximum value of the first type of LBT failure for each BWP; a maximum value of a second timer associated with a second type of LBT failure for each BWP; one or more physical random access channel (PRACH) occasions for each DL BWP; and a first time period for the LBT failure detection and recovery procedure in each DL BWP of the target cell.

Still another embodiment of the present disclosure provides an apparatus, comprising: a non-transitory computer-readable medium having stored thereon computer-executable instructions; a receiving circuitry; a transmitting circuitry; and a processor coupled to the non-transitory computer-readable medium, the receiving circuitry and the transmitting circuitry, wherein the computer-executable instructions cause the processor to implement the method a method performed by a user equipment (UE), which includes: performing a first listen before talk (LBT) procedure before transmitting an access message for a handover procedure; determining first LBT information and/or first handover failure (HOF) information when a HOF occurs; and transmitting the first LBT information and/or the first HOF information to a serving node of the UE.

### BRIEF DESCRIPTION OF THE DRAWINGS

FIG. 1 illustrates a schematic diagram of a wireless communication system in accordance with some embodiments of the present disclosure.

FIG. 2 illustrates a flow chart of a handover procedure with a LBT failure in the UE according to some embodiments of the present disclosure.

FIG. 3 illustrates a flow chart of a handover procedure with a LBT failure in the target node according to some embodiments of the present disclosure.

FIG. 4 illustrates a flow chart of a handover procedure with a LBT failure in the source node according to some embodiments of the present disclosure.

FIG. 5 illustrates a method performed by a UE for wireless communication according to an embodiment of the present disclosure.

FIG. 6 illustrates a method performed by a source node for wireless communication according to an embodiment of the present disclosure.

FIG. 7 illustrates a method performed by a source node for wireless communication according to an embodiment of the present disclosure.

FIG. 8 illustrates a method performed by a target node for wireless communication according to an embodiment of the present disclosure.

FIG. 9 illustrates a block diagram of a node according to the embodiments of the present disclosure.

### DETAILED DESCRIPTION

The detailed description of the appended drawings is intended as a description of the currently embodiments of the present invention, and is not intended to represent the only form in which the present invention may be practiced. It should be understood that the same or equivalent functions may be accomplished by different embodiments that are intended to be encompassed within the spirit and scope of the present invention.

While operations are depicted in the drawings in a particular order, persons skilled in the art will readily recognize that such operations need not be performed in the particular order shown or in sequential order, or that all illustrated operations be performed, to achieve desirable results, sometimes one or more operations can be skipped. Further, the drawings can schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing can be advantageous.

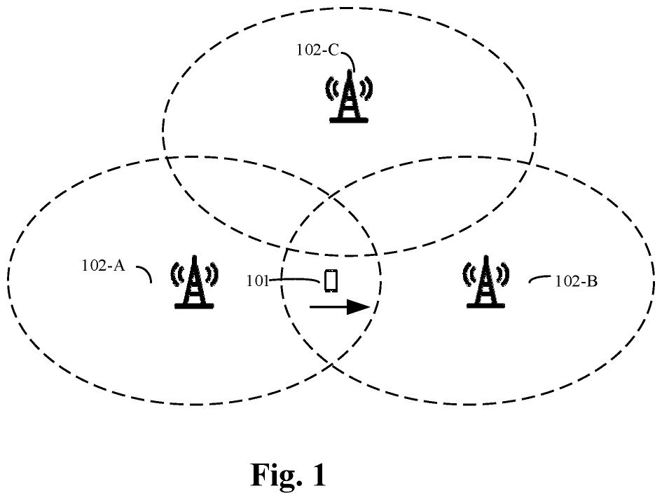

FIG. 1 depicts a wireless communication system according to an embodiment of the present disclosure.

As shown in FIG. 1, the wireless communication system includes UE 101, BS 102-A, BS 102-B, and BS 102-C. Even though a specific number of UE and BSs are depicted in FIG. 1, persons skilled in the art will recognize that any number of UEs and BSs may be included in the wireless communication system.

The UE 101 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, modems), or the like. According to an embodiment of the present disclosure, the UE 101 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments, the UE 101 includes wearable devices, such as smart watches, fitness bands, optical head-mounted displays, or the like. Moreover, the UE 101 may be referred to as subscriber units, mobiles, mobile stations, users, terminals, mobile terminals, wireless terminals, fixed terminals, subscriber stations, user terminals, a device, or by other terminology used in the art. The UE 101 may communicate directly with a BS via uplink (UL) communication signals.

The BSs may be distributed over a geographic region. In certain embodiments, a BS may also be referred to as an access point, an access terminal, a base, a base station, a macro cell, a Node-B, an enhanced Node B (eNB), a Home Node-B, a relay node, a device, or by any other terminology used in the art. The BSs are generally part of a radio access network that may include one or more controllers communicably coupled to one or more corresponding BSs.

The wireless communication system is compliant with any type of network that is capable of sending and receiving wireless communication signals. For example, the wireless communication system is compliant with a wireless communication network, a cellular telephone network, a Time Division Multiple Access (TDMA)-based network, a Code Division Multiple Access (CDMA)-based network, an Orthogonal Frequency Division Multiple Access (OFDMA)-based network, a LTE network, a 3rd Generation Partnership Project (3GPP)-based network, 3GPP 5G network, a satellite communications network, a high altitude platform network, and/or other communications networks.

In one implementation, the wireless communication system is compliant with the NR of the 3GPP protocol, wherein the BS transmits using an orthogonal frequency division multiplexing (OFDM) modulation scheme on the DL and the UE 101 transmits on the uplink using a single-carrier frequency division multiple access (SC-FDMA) scheme or OFDM scheme. More generally, however, the wireless communication system may implement some other open or proprietary communication protocol, for example, WiMAX, among other protocols.

In other embodiments, the BS may communicate using other communication protocols, such as the IEEE 802.11 family of wireless communication protocols. Further, in some embodiments the BS may communicate over licensed spectrum, while in other embodiments the BS may communicate over unlicensed spectrum. The present disclosure is not intended to be limited to the implementation of any particular wireless communication system architecture or protocol. In another embodiment, the BS may communicate with UE 101 using the 3GPP 5G protocols.

As shown in FIG. 1, the UE 101 is currently served by the BS 102-A, and is moving towards the BS 102-B. In this scenario, the UE 101 may need to perform the handover procedure from the BS 102-A to the BS 102-B. The BS 102-A is considered as the source node, the source BS, the source gNB, the source eNB, or the like. The BS 102-B is considered as the target node, the target BS, the target gNB, the target eNB, etc. During the handover procedure, if the handover to the BS 102-B fails, the UE101 may perform a re-establishment procedure, and re-connect/access to the BS 102-C. The BS 102-C is considered as the re-establishment node, the re-establishment BS, the re-establishment gNB, the re-establishment eNB, etc. Another possibility is that the UE may select the source node as the re-establishment node and re-connect/access to the BS 102-A. Thus, after handover fails, the serving node may be the source node or the re-establishment node.

Before performing any transmission such as the handover process in the unlicensed spectrum, both the UE and the BS should perform the LBT procedure and sense the wireless channel, in order to ensure that the spectrum is not occupied by other transmissions which may be generated by non-3GPP technologies such as WiFi.

The UE may be configured with a number of bandwidth parts (BWPs) in the unlicensed spectrum, after receiving the handover command, the UE starts timer T304, and performs LBT failure detection and recovery procedure before timer T304 expires. In LTE, the handover command may be a RRC connection reconfiguration message including the IE, mobilitycontrolinfo. In NR, the handover command may be a RRC reconfiguration message including the IE, ReconfigurationWithSync.

In the 3GPP documents, the media access control (MAC) entity may be configured by radio resource control (RRC) with a consistent LBT failure recovery procedure. Consistent LBT failure is detected per UL BWP by counting LBT failure indications, for all UL transmissions, from the lower layers to the MAC entity. For example, the UE or the BS may perform the LBT in a BWP, if the number of LBT failure in the physical layer within the valid time which represented as Ibt-FailureDetectionTimer, exceeds the maximum value, which may be represented as: Ibt-FailureInstanceMaxCount, then the UE has a consistent LBT failure in this BWP.

RRC configures the following parameters in the Ibt-FailureRecoveryConfig:
Ibt-FailureInstanceMaxCount for the consistent LBT failure detection; and
Ibt-FailureDetectionTimer for the consistent LBT failure detection.

The following UE variable is used for the consistent LBT failure detection procedure:
LBT_COUNTER (per serving cell): counter for LBT failure indication which is initially set to 0.

For each activated serving cell configured with Ibt-FailureRecoveryConfig, the MAC entity shall perform the following steps:
1>if LBT failure indication has been received from lower layers:
   2>start or restart the Ibt-FailureDetectionTimer;
   2>increment LBT_COUNTER by 1;
   2>if LBT_COUNTER>=Ibt-FailureInstanceMaxCount:
      3>trigger consistent LBT failure for the active UL BWP in this Serving Cell;
      3>if this Serving Cell is the SpCell:
         4>if consistent LBT failure has been triggered in all UL BWPs configured with PRACH occasions on same carrier in this Serving Cell:
         5>indicate consistent LBT failure to upper layers
         4>else:
         5>stop any ongoing Random Access procedure in this Serving Cell;
         5>switch the active UL BWP to an UL BWP, on same carrier in this Serving Cell, configured with PRACH occasion and for which consistent LBT failure has not been triggered;
         5>initiate a Random Access Procedure.

Based on the above, the present disclosure defines at least three types of LBT failures as follows:

The first type of LBT failure happens when a first indication is received from lower layer (e.g. physical layer). After the physical layer detects failure, a first indication is received from physical layer, then a counter (i.e., LBT_COUNTER) is incremented by 1, and a timer (i.e., Ibt-FailureDetectionTimer) is started or restarted. Then the UE performs the LBT procedure in the BWP until Ibt-FailureDetectionTimer or Ibt-FailureInstanceMaxCount is reached. The first type of the LBT failure may also be referred to as a kind of LBT failure in the present disclosure. Before T304 expires, the first type of LBT failure can be occurred in one or more BWPs.

For one BWP, the second type of LBT failure refers to a consistent LBT failure in this BWP. When the times of receiving the first indication in one BWP has reached to the maximum value, which may be represented as: Ibt-FailureInstanceMaxCount, or when the second timer is expired, i.e. Ibt-FailureDetectionTimer is reached, then the UE has a consistent LBT failure in this BWP. In other words, the number of the first type of LBT failure occurring in one BWP reaches the maximum value i.e. Ibt-FailureInstanceMaxCount, and in the present disclosure name it: the second type of LBT failure. The second type of the LBT failure may also be referred to as a kind of LBT failure in the present disclosure, or may also be referred to as the consistent LBT failure in one BWP in the present disclosure. Before T304 expires, the consistent LBT failure may have occurred in one or more BWPs, or the second type of LBT failure may have happened in at least one BWP.

The third type of the LBT failure refers to a consistent LBT failure in all of the configured BWPs. When the second type of the LBT failure in one BWP occurs, the LBT failure and recovery procedure is switched to other BWP, to determine whether the other BWP is available. When a consistent LBT failure occurs in all of the BWPs, a second indication is triggered, it is suggested that the third type of the LBT failure occurs. The third type of the LBT failure may also be referred to as a kind of LBT failure in the present disclosure. The second indication is sent from the MAC layer to the upper layer (i.e. RRC layer). The third type of the LBT failure may also be referred to as the consistent LBT failure in all BWPs configured with PRACH occasions in the present disclosure.

There are also two types of indications, which are referred to as the first indication and the second indication.

The first indication indicates the first type of the LBT failure. Once the first type of the LBT failure happens, the first indication is triggered. The first indication is transmitted from the physical layer to the MAC layer.

The second indication indicates the third type of the LBT failure. When the third type of the LBT failure happens, the second indication is triggered. The second indication is transmitted from the MAC layer to the RRC layer.

When T304 expires, there may be three forms of LBT related failure: 1) one or more first indications is received in one BWP but consistent LBT failure does not happen in this BWP, i.e. one or more first type of LBT failures happen in one BWP, and no second type of LBT failure or third type of LBT failure; 2) consistent LBT failure happens in at least one BWP but not in all the configured BWPs, i.e. one or more first type of LBT failures happen, at least one second type of LBT failure happens, no third type of LBT failure; 3) consistent LBT failure happens in all of the configured BWPs, i.e. third type of LBT failure happens.

Combining the handover procedure with the LBT procedure, there might be at least the following scenarios for the handover failure in NR-U.

In the first scenario, during the handover procedure, the LBT performed by the UE fails, i.e. when T304 expires one or more first indications are received in one UL BWP but consistent LBT failure does not happen in this UL BWP, or consistent LBT failure happens in at least one UL BWP but not in all the UL configured BWPs, or consistent LBT failure happens in all of the configured UL BWPs, and the UE attempts to re-establish the radio link connection in the source cell. In this scenario, the source node can be treated as the serving node in the present disclosure. The first scenario is considered as too early handover in NR-U, and the connection failure type can be set to “HOF” due to LBT related failure at UE side.

In the second scenario, during the handover procedure, the LBT performed by the UE fails, i.e. when T304 expires one or more first indications are received in one UL BWP but consistent LBT failure does not happen in this UL BWP, or consistent LBT failure happens in at least one UL BWP but not in all the UL configured BWPs, or consistent LBT failure happens in all of the UL configured BWPs, and the UE attempts to re-establish the radio link connection in a third cell other than the source cell or the target cell. The node that manages the third cell can be treated as the serving node in the present disclosure, e.g. the node is the re-establishment node. The second scenario is considered as handover to wrong cell in NR-U, and the connection failure type can be set to “HOF” due to LBT related failure at UE side.

For the first and the second scenarios, failure is caused due to LBT related failure at UE side, but the network does not know based on legacy RLF report. Mobility parameter optimization executed by the network may be unnecessary, since there is a possibility that previous mobility parameters are set properly and LBT configuration at the UE is set improperly. Unnecessary optimization for mobility parameter should be avoided. Therefore, it is desirable to distinguish mobility issue (e.g., improper mobility configuration) from LBT issue (e.g., improper LBT configuration).

In the third scenario, during the handover procedure, the LBT performed by the target node fails, i.e. one or more first indications are received in one DL BWP but consistent LBT failure does not happen in this DL BWP, or consistent LBT failure happens in at least one DL BWP but not in all the DL BWPs, or consistent LBT failure happens in all the DL BWPs, and the UE attempts to re-establish the radio link connection in the source cell. In this scenario, the source node can be treated as the serving node in the present disclosure. The third scenario is considered as too early handover in NR-U, and the connection failure type can be set to “HOF” due to LBT related failure at target node side.

In the fourth scenario, during the handover procedure, the LBT performed by the target node fails, i.e. one or more first indications are received in one DL BWP but consistent LBT failure does not happen in this DL BWP, or consistent LBT failure happens in at least one DL BWP but not in all the DL BWPs, or consistent LBT failure happens in all the DL BWPs, and the UE attempts to re-establish the radio link connection in a third cell other than the source cell or the target cell. The node that manages the third cell can be treated as the serving node in the present disclosure, e.g. the node is the re-establishment node. The fourth scenario is considered as handover to wrong cell in NR-U, and the connection failure type can be set to “HOF” due to LBT related failure at target node side.

For the third and the fourth scenarios, failure is caused due to LBT related failure at target node side, but the UE is not aware of that and it transmits legacy RLF report to the source node or to the serving node. The source node may receive legacy RLF report directly or indirectly, then it may execute mobility parameter optimization, however, it may be unnecessary since there is a possibility that previous mobility parameters are set properly and LBT configuration at the target node is set improperly. Unnecessary optimization for mobility parameter should be avoided. Therefore, it is desirable to distinguish mobility issue (e.g., improper mobility configuration) from LBT issue (e.g., improper LBT configuration).

In the fifth scenario, during the handover procedure, the LBT performed by the source node fails thus handover command can't be sent to the UE, and the UE detects RLF in the source cell, then the UE attempts to re-establish the radio link connection in a third cell other than the source cell or the target cell. The fifth scenario is considered as too late handover in NR-U system. In this scenario, the UE is not aware that the handover procedure at the source node side fails, and the UE may store or transmit the RLF report as legacy, then the source node would execute mobility parameter optimization as legacy. But it may be unnecessary to optimize mobility parameter since there is a possibility that previous mobility parameters are set properly and LBT configuration is improper. Unnecessary optimization for mobility parameter should be avoided. Therefore, it is advantageous for the source node to handle the RLF report taking the LBT information into consideration.

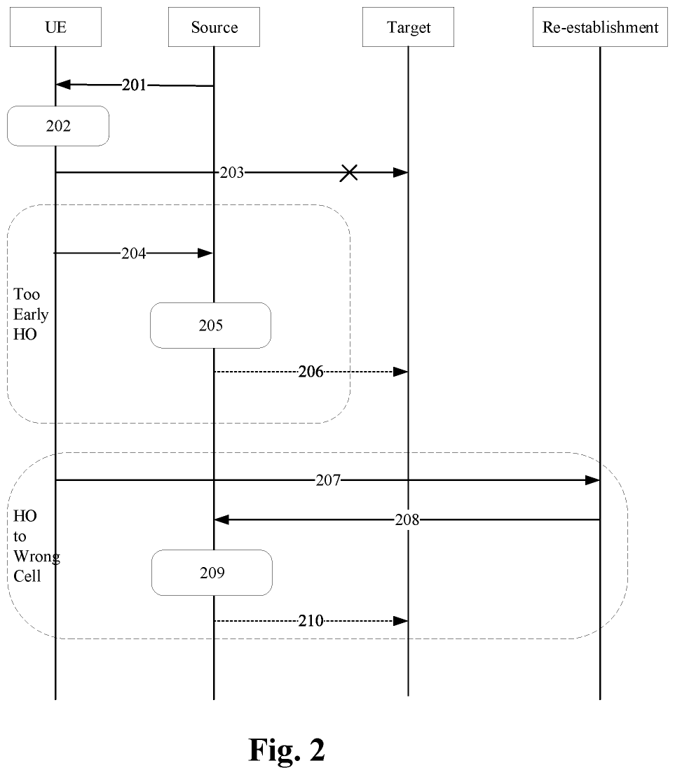

FIG. 2 illustrates a flow chart of a handover procedure with a LBT failure in the UE according to some embodiments of the present disclosure. That is, FIG. 2 describes the above first and second scenarios.

FIG. 2 includes four components, which are: the UE (the “UE” as depicted in FIG. 2), the source node (the “source” as depicted in FIG. 2), the target node (the “target” as depicted in FIG. 2), and the re-establishment node (the “re-establishment” as depicted in FIG. 2).

In step 201, the source node transmits a handover command to the UE, the command may be the RRC Reconfiguration message, which includes the information element (IE) ReconfigurationWithSync. Since the UE is operating in the unlicensed spectrum, the UE would perform LBT before transmitting an access message to the target node. The access message may be a preamble, a message 3 (MSG3), a message A (MSG A).

After receiving the handover command from the source node, the UE starts timer T304, which counts the time for the handover procedure, and performs the LBT procedure. When timer T304 expires, the UE determines that the handover procedure fails, no matter whether the LBT procedure is successful or not.

In step 202, the UE initiates a LBT procedure, and the LBT procedure fails. Therefore, the UE cannot occupy the unlicensed channel, and in step 203, HOF occurs when T304 expires, e.g. the random access channel (RACH) procedure to the target node fails. Under this condition, the UE starts a RRC re-establishment procedure, and establishes the radio link connection to the source cell or a third cell

It should be noted that steps 201-203 apply for both the first scenario e.g. too early handover scenario and the second scenario e.g. handover to wrong cell scenario. More specifically, steps 201-203 and steps 204-206 together are considered as the flow chart for the first scenario e.g. the too early handover scenario; steps 201-203 and steps 207-210 together are considered as the flow chart for the second scenario e.g. the handover to wrong cell scenario.

Steps 201-203 and steps 204-206 describe the mobility robustness optimization (MRO) procedure for abovementioned first scenario, i.e. the too early handover scenario. If the UE attempts to re-establish the radio link connection in the source cell, in step 204, the UE transmits the LBT information and/or the HOF information to the source node. Supposing that the UE is configured with 4 UL BWPs, the maximum value of the LBT failure, i.e., Ibt-FailureInstanceMaxCount, is set to an integer number such as 10 for each UL BWP. The parameter Ibt-FailureInstanceMaxCount for different BWP may be set to different integers.

The LBT information may include at least one of the following information:
1. cause for HOF, e.g., at UE side, the first type of LBT failure, the second type of LBT failure, or the third type of LBT failure has been triggered in the target cell's uplink (UL) BWPs, which are configured with physical random access channel (PRACH) occasions when timer T304 is running.
For example, when timer T304 expires, there might have been a first type of LBT failure, a consistent LBT failure in one UL BWP, two consistent LBT failures in two UL BWPs, three consistent LBT failures in three UL BWPs, or four consistent LBT failures in the four UL BWPs.
2. the number of the first indication from UE's physical layer per BWP when timer T304 is running.
For example, when timer T304 expires, the first type of LBT failure may have happened twice in the first BWP.
3. the total number of the first indication from UE's physical layer when timer T304 is running.
For example, when timer T304 expires, the second type of LBT failure is triggered in the first BWP, and the first type of LBT failures are triggered twice in the second BWP. Therefore, when timer T304 expires, the total number of the first indication, i.e., the first indication which indicates the first type of LBT failure, is 10 plus 2, which is 12.
4. the total number of UL BWPs where LBT failure detection and recovery is performed in target cell when timer T304 is running. For example, the total number of UL BWPs where LBT failure detection and recovery is performed in target cell may be 3, then timer T304 expires.
5. The second indication, in other words, the indication about whether consistent LBT failure has been triggered in all target cell's UL BWPs configured with PRACH occasions when timer T304 is expired; or indication about whether the second indication has been received from the UE's MAC layer when timer T304 is expired.
6. a time point of when the second indication is triggered. The second indication, i.e., the consistent LBT failure indication from the MAC layer is received:
   i. before transmitting preamble;
   ii. before transmitting MSG3; or
   iii. before transmitting MSG A.
The above time points may be indicated with different indicators, for example, the first indicator indicates time point i), the second indicator indicates time point ii), and the third indicator indicates time point iii).
7. the maximum allowed number of the first type of LBT failure for each BWP in the target cell, or a maximum value of the first type of LBT failure for each BWP, i.e., Ibt-FailureInstanceMaxCount. For instance, the maximum allowed number of the first type of LBT failure may be 10, that is to say, after 10 first type of LBT failures in the BWP, a consistent LBT failure is triggered for the BWP, that is, the second type of LBT failure is triggered for the BWP.
8. the maximum allowed period for consistent LBT failure detection for each BWP in the target cell, or a maximum value of a second timer associated with a second type of LBT failure for each BWP, i.e., Ibt-FailureDetectionTimer. For instance, the maximum allowed period for consistent LBT failure detection may be 10 ms, that is to say, after 10 ms of performing the LBT in the BWP, a consistent LBT failure is triggered for the BWP, that is, the second type of LBT failure is triggered for the BWP.
9. one or more physical random access channel (PRACH) occasions per BWP where LBT is performed.
10. time elapsed in the UE for LBT failure detection and recovery per target cell's BWP.
11. time elapsed since the last handover initialization until consistent LBT failure indication has been received from the UE's MAC layer, if consistent LBT failure indication is received before timer T304 expires. That is, the time period from the time point the handover procedure is triggered to the time point that the second indication is received.
12. time elapsed since consistent LBT failure indication has been received from the UE's MAC layer until handover failure, if consistent LBT failure indication is received before timer T304 expires. That is, the time period from the time point that the consistent LBT failure is triggered in all the BWPs or the second indication is received, to the time point that the handover fails.
13. one or more measurement results, for example, the signal receiving power (RSRP), the reference signal receiving quality (RSRQ), the signal to interference plus noise ratio (SINR), of the target cell at the moment when the second type of LBT failure occurs per BWP in the target cell.
For instance, measurement results may include:
   i. the RSRP of the target cell when consistent LBT failure or the second type of LBT failure occurs in the 1^{st} BWP in the target cell;
   ii. the RSRP of the target cell when consistent LBT failure or the second type of LBT failure occurs in the 2^{nd} BWP in the target cell;
   iii. the RSRP of the target cell when consistent LBT failure or the second type of LBT failure occurs in the 3^{rd} BWP in the target cell; and
   iv. the RSRP of the target cell when consistent LBT failure or the second type of LBT failure occurs in the 4^{th} BWP in the target cell.
14. measurement result of the target cell at the moment when the second indication has been received from the MAC layer if the second indication is received before timer T304 expires. For instance, the measurement result may be the RSRP and/or RSRQ and/or SINR of the target cell when the third type of LBT failure occurs.
15. measurement result of the source cell at the moment when consistent LBT failure occurs per BWP in the target cell.
For instance, measurement results may include:
   i. the RSRP of the source cell when consistent LBT failure or the second type of LBT failure occurs in the 1^{st} BWP in the target cell;
   ii. the RSRP of the source cell when consistent LBT failure or the second type of LBT failure occurs in the 2^{nd} BWP in the target cell;
   iii. the RSRP of the source cell when consistent LBT failure or the second type of LBT failure occurs in the 3^{rd} BWP in the target cell; and
   iv. the RSRP of the source cell when consistent LBT failure or the second type of LBT failure occurs in the 4^{th} BWP in the target cell.
16. measurement result of the source cell at the moment when the second indication has been received from the MAC layer, if the second indication is received before timer T304 expires. For instance, the measurement result may be the RSRP and/or RSRQ and/or SINR of the source cell when the third type of LBT failure occurs.

The HOF information, which may be included in the radio link failure (RLF)

report, or the stored handover failure related information in VarRLF-Report, may include at least one of the following information:
1. The cell global identifier (CGI) of the last cell that served the UE (in case of RLF) or the target of the handover (in case of handover failure).
2. The CGI of the cell towards which the UE wants to initiate re-establishment attempt.
3. The CGI of the cell that served the UE at the last handover initialization.
4. Time elapsed since the last handover initialization until the RRC connection failure.
5. Time elapsed from the RRC connection failure till RLF Report signalling.
6. Time elapsed from the RRC connection failure till re-connection.
7. An indication whether the RRC connection failure was due to RLF or handover failure.
8. Cell Network Temporary Identifier (RNTI) C-RNTI allocated for the UE in the last serving cell.
9. Handover type i.e., intra-system or inter-system handover should be included in both evolved UMTS terrestrial radio access network (E-UTRAN) and NR UE RLF report.
10. Information on radio resource management (RRM) measurements per beam on a serving cell (where RLF is detected) and on target cell (in case of handover failure)
   i. Beam level measurement for cell quality derivation;
   ii. Beam level measurement on at least one neighbour cell for cell quality derivation;
   iii. Beam level measurement on a cell the UE selects and performs reestablishment after RLF;
   iv. Measurement can be done on different RS types such as:
      a) synchronization signal and pbch block (SSB);
      b) channel state information—reference signal (CSI-RS);
      c) tracking reference signal (TRS), demodulation reference signal (DMRS) or any combination of these signals.
   v. RACH related information:
      a) beam identity where RACH access was attempted during handover;
      b) Number of RACH attempts for each RACH access attempt.
11. Logging sensor data, including UE orientation or altitude to log in addition to location, speed and heading (e.g., digital compass, gyroscope as well as barometer, etc.).
12. UE speed state, which may be low, mid, or high, detected by UE as part of speed-based scaling procedure.

In step 205, the source node analyzes the failure cause based on the LBT information and/or the HOF information transmitted from the UE.

The failure cause of the too early handover may be caused by different failure types, the failure type may be the inappropriate LBT configuration, and/or, inappropriate mobility configuration. Based on the determined failure type, in step 206, the source node may transmit a first message to the target node to indicate the target node to optimize LBT configuration when the failure type is inappropriate LBT configuration, or the source node may transmit a second message to the target node to indicate the target node to optimize mobility configuration when the failure type is inappropriate mobility configuration. If the failure type is inappropriate LBT configuration and inappropriate mobility configuration, the source node may transmit one message to the target node to indicate the target node to optimize LBT configuration and mobility configuration. Then the target node would perform corresponding optimization based on the message(s) from the source node.

For example, if the message indicates the target node to optimize the LBT configuration, the target node correspondingly optimizes the LBT configuration; if the message indicates the target node to optimize the mobility configuration, the target node correspondingly optimizes the mobility configuration; or if the message indicates the target node to optimizes the LBT configuration and the mobility configuration, the target node correspondingly optimizes the LBT configuration and the mobility configuration.

Optionally, the re-establishment node or the source node may transmit one message to the UE for optimizing LBT configuration and/or mobility configuration

In handover to wrong cell scenario, the UE may attempt to re-establish the radio link connection in a cell other than the source cell or the target cell, which is depicted as “re-establishment” in FIG. 2. Steps 201-203 and steps 207-210 describe MRO procedure for the abovementioned second scenario, i.e. the handover to wrong cell scenario.

After step 203, if the UE attempts to re-establish the radio link connection in the re-establishment cell, after accessing to the re-establishment cell, in step 207, the UE transmits the LBT information and/or the HOF information to the re-establishment node, in step 208, the re-establishment node transmits the LBT information and/or the HOF information received from the UE to the source node. The LBT information and the HOF information are similar as those explained in step 204, and the details are omitted here. In step 209, the source node analyzes the failure cause based on the LBT information and/or the HOF information forwarded by the re-establishment node. The detailed operations for failure cause analysis by the source node are similar as step 205.

The failure cause of the handover to wrong cell may be caused by different failure types, the failure type may be the inappropriate LBT configuration, and/or, inappropriate mobility configuration. Based on the determined failure type, in step 210, the source node performs similar operations as in step 206. Please refer to the description of step 206, the target node and the source node correspondingly performs similar operations too.

In some embodiments, the handover command transmitted in step 201 may include thresholds of a source cell and/or a target cell, which indicates the signal strength thresholds. Supposing that the threshold for the target cell is represented with “P”, and the threshold for the source cell is represented with “Q”. The threshold P or Q may also be defined in the specification. Before the step 204, the UE may analyze whether to store or send the HOF information using the thresholds P or Q.

For example, when timer T304 expires (i.e., the handover failure occurs), the UE may determine the first measurement result, M₁, of the target cell, the measured parameter may be the PSPR, RSRQ, or SINR of the target cell. Then the UE compares M₁, with a threshold, P, when M₁>P, it is suggested that the signal strength of the target cell is relatively good, and the handover failure may be caused by the LBT failure, such as the LBT failure or consistent LBT failure in one or more uplink BWPs triggered at the UE, thus, the UE would not store or send HOF information. The UE may store LBT information when LBT related failure happens or HOF happens. In this scenario, the UE may optimize LBT configuration when HOF occurs, or receive an indication for optimizing LBT configuration from a serving node, the a serving node may be the re-establishment node or the source node. When M₁<P, it is suggested that the signal strength of the target cell is relatively bad, the UE determines that the handover failure is caused by improper mobility configuration but can't exclude that failure is also caused by LBT related failure, then the UE stores and/or transmit the HOF information.

The UE may also determine the second measurement result, M₂, of the source cell, the measured parameter may be the PSPR, RSRQ, or SINR of the source cell. Then the UE compares M₂, with a threshold, for example, Q, when M₂>Q, it is suggested that the signal strength of the source cell is relatively good, the timing might be too early for the UE to perform the handover procedure. Thus, the UE may store and/or send HOF information. If the M₂<Q, it is suggested that the signal strength of the source cell is relatively bad, and the handover failure may be caused by the LBT related failure, such as the LBT failure or consistent LBT failure in one or more UL BWPs triggered at the UE, thus, the UE would not store or send HOF information. In this case, the UE may optimize LBT configuration when HOF occurs.

In some cases, the UE compares M₁, with the threshold, P, and M₂, with the threshold, Q, simultaneously. Only when M₁>P, and M₂<Q, which suggests that the signal strength of the target cell is relatively good, and the signal strength of the source cell is relatively bad, the UE determines that the handover failure may be not caused by mobility issue, and it may be caused by the LBT related failure, such as the LBT failure or consistent LBT failure in one or more UL BWPs triggered at the UE, thus, the UE would not store or send HOF information. In this case, the UE may store LBT information when LBT related failure occurs or HOF occurs, optionally the UE may optimize LBT configuration when HOF occurs.

When M₁<P, and M₂>Q, which suggests that the signal strength of the target cell is relatively bad, and the signal strength of the source cell is relatively good, the UE determines that handover failure may be caused by mobility issue, e.g. handover procedure is triggered too early. Thus, in this case, the UE may store LBT information when LBT related failure occurs or HOF occurs, the UE may also store and/or send HOF information.

In other embodiment, if LBT related failure has occurred in the UE, when HOF happens, no matter whether the UE stores or reports the HOF information or not, the UE may store or report the LBT information.

If the UE does not store the HOF information but stores the LBT information, the UE may send the LBT information to the serving node via RRC message, for example, via the UE Information Response message, or Layer 2 message, such as a MAC control element (CE), the serving node can be the source node or the re-establishment node. Before the UE sends the LBT information, the UE may indicate to the serving node that it has stored the LBT information, and then the serving node would request the LBT information from the UE, e.g. the serving may send the UE Information Request message.

If the UE stores the HOF information and the LBT information, the LBT information and the HOF information may be sent by the UE via the same one message or two independent messages to the serving node. The message may be UE Information Response message. Before the UE sends the LBT information and the HOF information, the UE may indicate to the serving node that it has stored the LBT information and the HOF information, and then the serving node would request the LBT information and the HOF information from the UE via a same request message or two independent request messages, e.g. the serving may send one or two UE Information Request message(s).

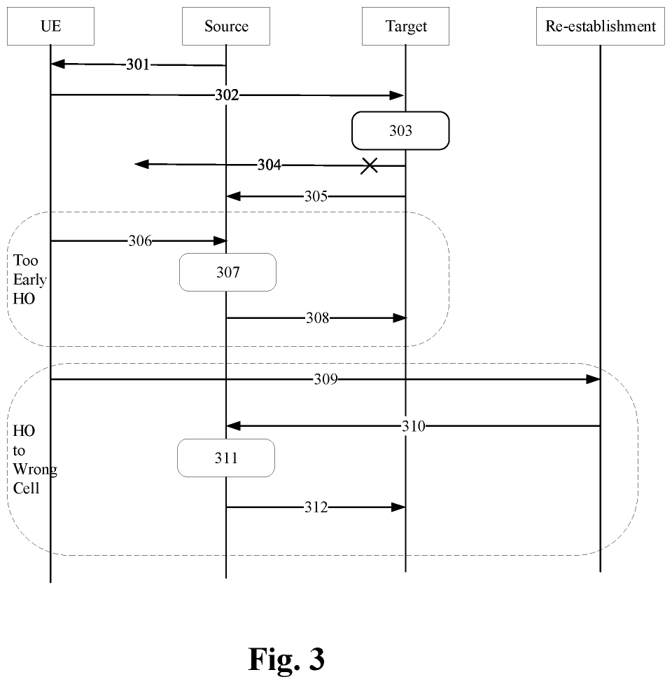

FIG. 3 illustrates a flow chart of a handover procedure with LBT related failure in the target node according to some embodiments of the present disclosure. That is, FIG. 3 describes the above third and fourth scenarios. FIG. 3 also includes the four components as those in FIG. 2.

In step 301, the source node transmits a handover command to the UE, the command may be the RRC Reconfiguration message, which includes the IE ReconfigurationWithSync. After a successful LBT procedure, in step 302, the UE transmits an access message to the target node. The access message may be a preamble, a MSG3, a MSG A.

After receiving the access message from the UE, the target node initiates a LBT procedure, and the LBT procedure fails. Therefore, the target node cannot occupy the unlicensed channel, and in step 304, the response to the access message of the UE is not transmitted. The response may be the random access response (RAR), a message 4 (MSG 4), or a message B (MSGB).

When timer T304 expires, the UE determines that the handover procedure fails, the UE may re-establish the radio link connection in the source cell or a third cell, i.e. after handover procedure fails, the serving node may be the source node or the re-establishment node.

In step 305, the target node can send one message to the source node to indicate LBT related failure occurred in the target node, the message can be a new message or currently existing message, e.g., current HANDOVER REPORT message may be re-used. Supposing that the target node is configured with 4 DL BWPs, the maximum value of the LBT failure, i.e., Ibt-FailureInstanceMaxCount, is set to an integer number such as 10 for each DL BWP. The parameter Ibt-FailureInstanceMaxCount for different BWP may be set to different integers.

It should be noted that steps 301-305 apply for both the third scenario e.g. too early handover scenario and the fourth scenario e.g. handover to wrong cell scenario. More specifically, steps 301-305 and steps 306-308 together are considered as the flow chart for the third scenario e.g. the too early handover scenario; steps 301-305 and steps 309-312 together are considered as the flow chart for the fourth scenario e.g. the handover to wrong cell scenario.

The message (e.g., message Z) may include at least one of the following information:
1. cause for HOF, e.g., at the target node side, the first type of LBT failure, the second type of LBT failure, or the third type of LBT failure has been triggered in one or more target cell's DL BWPs, since receiving the access message from the UE.

For example, a first type of LBT failure in one DL BWP, a consistent LBT failure in one DL BWP, two consistent LBT failures in two DL BWPs, three consistent LBT failures in three DL BWPs, or four consistent LBT failures on the four DL BWPs may be triggered.
2. LBT failure indication, i.e., the first indication.
3. consistent LBT failure indication, i.e., the second indication.
4. the number of the first indication from target cell's physical layer per BWP since receiving preamble;

For instance, the first indication in the first BWP may be 10, the first indication in the second BWP may be 10, the first indication in the second BWP may be 9, and the first indication in the fourth BWP may be 8.
5. the total number of first indication from target cell's physical layer since receiving preamble, that is, the sum of the first indication in each BWP.
6. the total number of DL BWPs where LBT failure detection and recovery is performed in the target cell since receiving preamble; e.g., 4 DL BWPs.
7. a time point of when the first indication or the second indication is triggered. The time point may be:
   i. before transmitting RAR;
   ii. before transmitting MSG4; or
   iii. before transmitting MSG B.

The above time points may be indicated with different indicators, for example, the first indicator indicates time point i), the second indicator indicates time point ii), and the third indicator indicates time point iii).
8. the maximum allowed number of the first type of LBT failure for each BWP applied by the target node, or a maximum value of the first type of LBT failure for each BWP, i.e., Ibt-FailureInstanceMaxCount. For instance, the maximum allowed number of the first type of LBT failure may be 10, that is to say, after
10. first type of LBT failures in the BWP, a consistent LBT failure is triggered for the BWP, that is, the second type of LBT failure is triggered for the BWP.
9. the maximum allowed period for consistent LBT failure detection per BWP applied by the target node, or a maximum value of a second timer associated with a second type of LBT failure for each BWP, i.e., Ibt-FailureDetectionTimer. For instance, the maximum allowed period for consistent LBT failure detection may be 10 ms, that is to say, after 10 ms of performing the LBT in the BWP, consistent LBT failure is triggered for the BWP, that is, the second type of LBT failure is triggered for the BWP.
10. PRACH occasions per BWP applied by the target node;
11. Elapsed time for LBT failure detection and recovery per BWP in the target node.

Steps 301-305 and Steps 306-308 describe the MRO procedure for abovementioned third scenario, i.e. the too early handover scenario. If the UE re-establishes the radio link connection in the source cell, In step 306, the UE transmits a RLF report to the source node. The RLF report may be legacy RLF report, and may include the second HOF information, which is similar information as the HOF information described in FIG. 2.

In step 307, the source node determines the failure cause based on the RLF report from the UE and the message Z from the target node.

In step 307, the source node determines the failure cause. The failure may be caused by the inappropriate LBT configuration, and/or, inappropriate mobility configuration. In step 308, based on the determined failure type, the source node may transmit a first message to the target node to indicate the target node to optimize LBT configuration when the failure type is inappropriate LBT configuration, or the source node may transmit a second message to the target node to indicate the target node to optimize mobility configuration when the failure type is inappropriate mobility configuration. If the failure type is inappropriate LBT configuration and inappropriate mobility configuration, the source node may transmit one message to the target node to indicate the target node to optimize LBT configuration and mobility configuration. Then the target node would perform corresponding optimization based on the message(s) from the source node.

For example, if the message indicates the target node to optimize the LBT configuration, the target node correspondingly optimize the LBT configuration; if the message indicates the target node to optimize the mobility configuration, the target node correspondingly optimizes the mobility configuration; or if the message indicates the target node to optimizes the LBT configuration and the mobility configuration, the target node correspondingly optimizes the LBT configuration and the mobility configuration. Optionally, the target node may optimize LBT configuration upon LBT related failure occurs in the target node.

In the fourth scenario, that it, the handover to wrong cell scenario, the UE re-establishes the radio link connection in a cell other than the source cell or the target cell. The serving node is the re-establishment node. Steps 301-305 and steps 309-312 describe MRO procedure for the abovementioned fourth scenario, i.e. the handover to wrong cell scenario.

In step 309, the UE transmits the RLF report to the re-establishment node. In step 310, the re-establishment node forwards the RLF report to the source node. The detailed information in the RLF report may refer to the HOF information described in FIG. 2.

In step 311, based on the message Z from the target node received in step 305, and/or the RLF report forwarded by the re-establishment node, the source node determines the failure type.

In step 311, the source node determines the failure cause. The failure may be caused by the inappropriate LBT configuration, and/or, inappropriate mobility configuration. In step 312, based on the determined failure type, the source node may transmit a first message to the target node to indicate the target node to optimize LBT configuration when the failure type is inappropriate LBT configuration, or the source node may transmit a second message to the target node to indicate the target node to optimize mobility configuration when the failure type is inappropriate mobility configuration. If the failure type is inappropriate LBT configuration and inappropriate mobility configuration, the source node may transmit one message to the target node to indicate the target node to optimize LBT configuration and mobility configuration. Then the target node would perform corresponding optimization based on the message(s) from the source node.

For example, if the message indicates the target node to optimize the LBT configuration, the target node correspondingly optimize the LBT configuration; if the message indicates the target node to optimize the mobility configuration, the target node correspondingly optimizes the mobility configuration; or if the message indicates the target node to optimizes the LBT configuration and the mobility configuration, the target node correspondingly optimizes the LBT configuration and the mobility configuration. Optionally, the target node may optimize LBT configuration upon LBT related failure occurs in the target node.

For the first scenario, second scenario, third scenario and the fourth scenario, if the source node decides that mobility parameters need to be modified, the source node can indicate the target node to configure the cell where the UE re-connects to as the target cell for subsequent handover procedure, and/or, the source node can indicate the target node to optimize mobility parameters, such as modifying HO triggering threshold, time-to-trigger (TTT) for radio resource management (RRM) measurement and etc. For example, when the measurement result of the target cell at the moment that HOF occurs that included in the RLF report is not good enough, and/or, when the measurement result of the source cell at the moment that HOF occurs that included in the RLF report is good enough, the source node decides that mobility parameters need to be modified.

For the first scenario, second scenario, third scenario and the fourth scenario, if the source node decides that LBT configuration at the target node needs to be optimized, optionally, the source node can send one message to the target node to indicate it to perform optimization for LBT configuration. For example, when the source node finds that the HOF is due to improper LBT configuration, the source node decides that LBT configuration at the target node needs to be optimized.

For the first scenario, second scenario, third scenario and the fourth scenario, in another embodiment, the source node may not transmit the indication to the target node for indicating the target node to improve the LBT configuration. The target node may optimize the LBT configuration when LBT related failure happens, e.g., it can optimize the IE Ibt-FailureInstanceMaxCount, and/or the IE Ibt-FailureDetectionTimer. The target node may enlarge the execution time of LBT failure detection and recovery procedure for the high priority access channel, and/or it may reduce the execution time of LBT failure detection and recovery procedure for the low priority access channel.

For the first scenario, second scenario, third scenario and the fourth scenario, in one embodiment, the target node may support the uplink measurement. The measurement result may include the RSRP, RSRQ, or the SINR.

When LBT related failure happens at target node, the target node can optimize the LBT configuration, and the target node can send the message V, to the source node to indicate LBT failure or consistent LBT failure occurred in the target node. For example, the contents included in the message V can be similar as the ones included in the message Z transmitted in step 305 in FIG. 3.

Supposing that there is a threshold, for example, M, the target node may determine a measurement result of the target cell at the moment when LBT failure or consistent LBT failure occurs. Supposing that the measurement result for the target cell is represented with “M_{T}”, if “M_{T}” is higher than the threshold M, i.e., M_{T}>M, it is suggested that the signal strength of the target cell is relatively good, and the handover failure may be caused by the LBT failure, the message V can also be used to indicate the source node to ignore the received RLF report if any, i.e., one additional indication can be included in the message V to indicate the source node to ignore/remove/discard the RLF report if the RLF report is received from the UE or the re-establishment node, then, when the source node receives RLF report it would ignore it, or discard it, or remove it. The threshold M can be defined in the specification or defined by the target node.

If M_{T}<M, it is suggested that the target cell quality is relatively bad, and the handover failure may be caused by improper mobility configuration, the source node may make failure cause analysis, e.g. it may decide whether it is caused by the mobility issue, e.g., improper or inappropriate mobility configuration, and/or LBT issue, e.g., improper LBT configuration, based on the message V and/or the RLF report.

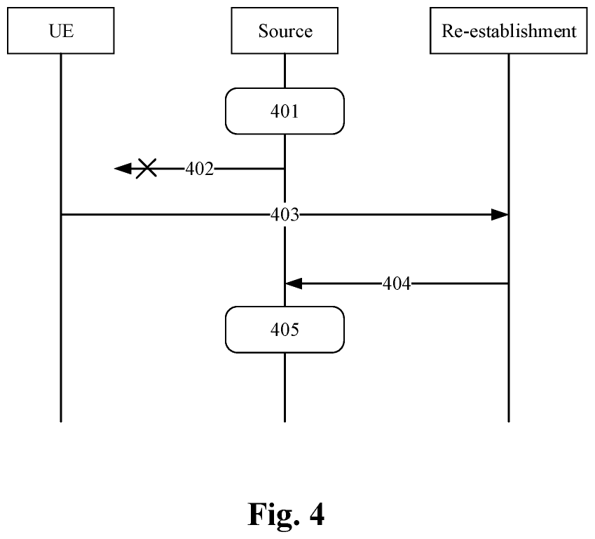

FIG. 4 illustrates a flow chart of a handover procedure with a LBT failure in the source node according to some embodiments of the present disclosure.

FIG. 4 includes three components, which are: the UE, the source node, and the target node. FIG. 4 describes the fifth scenario, that is, during the handover procedure, the LBT performed by the source node fails, thus handover command can't be sent to the UE, the UE detects RLF in the source cell, then the UE re-establishes the radio link connection in the third cell other than the source cell. The fifth scenario is considered as too late handover in NR-U system.

In order to transmit the handover command, i.e., the RRC Reconfiguration message including the IE ReconfigurationWithSync, to the UE, in step 401, the source node performs a LBT procedure. However, the LBT procedure fails due to LBT related LBT failure, therefore, the UE detects RLF in the source cell, and the handover command in step 402 may not be transmitted to the UE.

Since the UE detects RLF occurred in the source node, and then the UE may perform a re-establishment procedure and access to the re-establishment cell. Then in step 403, the UE may transmit the RLF report to the re-establishment node. In step 404, the re-establishment node forwards the RLF report to the source node. The detailed RLF report may refer to the RLF report described in FIG. 2.

In some embodiments, after receiving the RLF report, the source node may analyze the failure cause and make corresponding optimization. For example, the source node may detect that failure is caused due to the source node triggers the handover command too late, then it can optimize mobility parameters, e.g., reduce HO triggering threshold, reduce TTT for RRM measurement and etc. The source node may trigger handover command earlier.

In some embodiments, since the source node is aware that the RLF is caused by the LBT failure at the source node, the source node can ignore or remove the RLF report forwarded by the re-establishment node. And, the source node may decide that the failure is LBT related failure. The source node may optimize LBT configuration.

Optionally, if the measurement result (such as the measurement of RSRP, RSRQ, or SINR) of the source cell at the moment when RLF occurs is higher than one threshold (which means the cell quality of the source cell is relatively good), the source node can ignore or remove the RLF report when receiving it and determine the failure type as consistent LBT failure or consistent LBT failure; otherwise, it can optimize mobility parameters based on the RLF report. The measurement result can be measured by the source node.

Additionally, if the source node has generated the handover command but cannot send it due to LBT failure, the source node may optimize the LBT configuration, e.g., it can optimize the IE Ibt-FailureInstanceMaxCount, and/or the IE bt-FailureDetectionTimer, and/or source node may enlarge the execution time of LBT failure detection and recovery procedure for the high priority access channel, and/or it can reduce the execution time of LBT failure detection and recovery procedure for the low priority access channel.

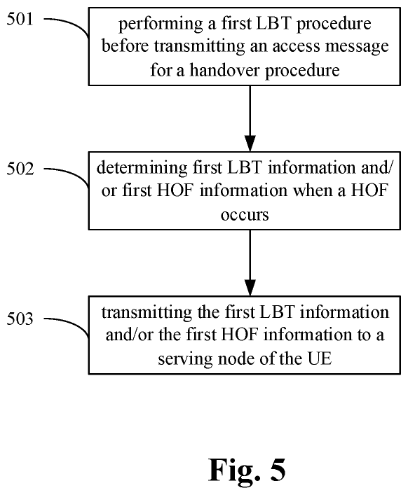

FIG. 5 illustrates a method performed by a UE for wireless communication according to an embodiment of the present disclosure.

In step 501, the UE performs a first LBT procedure before transmitting an access message for a handover procedure. The access message may include a preamble, a MSG3 in a step-4 RACH procedure, or a MSG A in a step-2 RACH procedure.

In step 502, the UE determines the first LBT information and/or first handover failure (HOF) information when a HOF occurs. The first LBT information may be stored when the first type of LBT failure (i.e., at least one first indication is received in one BWP but consistent LBT failure does not happen in this BWP) happens, when the second type of LBT failure (i.e., consistent LBT failure happens in at least one BWP but not in all the configured BWPs) happens, or when the third type of LBT failure (i.e., consistent LBT failure happens in all of the configured BWPs) happens. Alternatively, the first LBT information may be stored when the HOF happens. The HOF information is stored when the HOF occurs.

In step 503, the UE transmits the first LBT information and/or the first HOF information to a serving node of the UE. Alternatively, the UE may store the first LBT information and/or the first HOF information without transmitting them. Alternatively, the UE may both store and transmit the first LBT information and/or the first HOF information. The serving node can be the source node or the re-establishment node.

In some embodiment, the UE may determine whether to store or transmit the first LBT information and/or the first HOF information. For example, the UE may store the first HOF information if a first measurement result associated with a target cell when a first timer expires is lower than a first predefined value, and/or a second measurement result associated with a source cell when the first timer expires is higher than a second predefined value. After storing the first HOF information, the UE may transmit it to the serving node of the UE. The measurement may be the RSRP, the RSRQ, the SINR, of the target cell, or any signal measurement that can reflect the cell quality of the target cell. If first measurement result is higher than the first predefined value, and/or the second measurement result is lower than the second predefined value, the UE does not store the first HOF information, nor transmit it to the serving node of the UE. The first LBT information is similar to those LBT information determined by the UE as illustrated in step 204 in FIG. 2

In some embodiments, the first LBT information and the first HOF information are transmitted in a same message or in different messages. In other embodiments, when determining that the LBT configuration needs to be improved, the UE may optimize the LBT configuration.

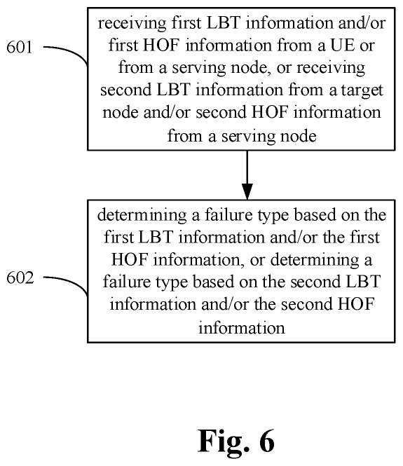

FIG. 6 illustrates a method performed by a source node for wireless communication according to an embodiment of the present disclosure.

In step 601, the source node may receive the first LBT information and/or first HOF information from the UE, or from a serving node, i.e. the re-establishment node. For example, in FIG. 2, in step 204, the source node receives the first LBT information and/or first HOF information from the UE; and in step 207, the source node receives the first LBT information and/or first HOF information of the UE from the re-establishment node.

In source node may receive the second LBT information from a target node and/or second HOF information from a serving node, i.e. the re-establishment node. For example, in FIG. 3, the source node may receive the second LBT information from the target node in step 305, and receive the second HOF information from the UE or from the re-establishment node. The second HOF information is transmitted from the UE to the re-establishment node, and forwarded to the source node by the re-establishment node.

It should be noted that the first HOF information is generated by the UE under that condition that the UE is aware that the LBT procedure of the UE fails, while the second HOF information is generated by the UE under that condition that the UE is not aware that the LBT procedure at target node fails, thus the detailed parameters for the two HOF information are different.

In step 602, the source node determines a failure type based on the first LBT information and/or the first HOF information, or determining a failure type based on the second LBT information and/or the second HOF information.

For example, the failure type may be inappropriate mobility configuration and/or inappropriate LBT configuration. When the failure type shows that LBT configuration is inappropriate, the source node may transmit a message to the target node, which indicates that the LBT configuration of the target node needs to be optimized. When the failure type shows that mobility configuration is inappropriate, the source node may also transmit a message to indicate to the target node that the mobility configuration needs to be improved.

The first LBT information is similar to those LBT information determined by the UE as illustrated in step 204 in FIG. 2, and the second LBT information is similar to those LBT information determined by the target node as illustrated in step 305 in FIG. 3. The second LBT information is included in the message Z or message V.

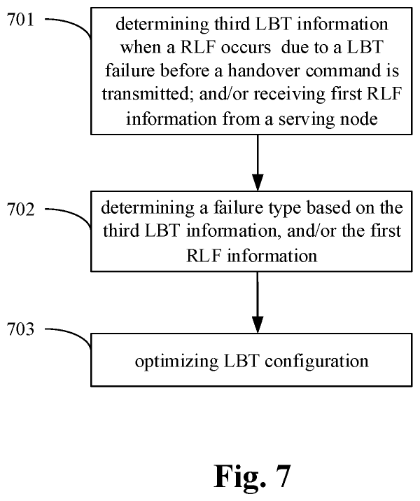

FIG. 7 illustrates a method performed by a source node for wireless communication according to an embodiment of the present disclosure.

In step 701, the source node determines the third LBT information when a RLF occurs due to a LBT failure before a handover command is transmitted. For example, as shown in FIG. 4, the source node performs a LBT procedure before transmitting the handover command, and the source node determines the third LBT information. The source node may also receive the first RLF information from a serving node, for instance, as shown in step 404 of FIG. 4, the source node receives the first RLF information generated by the UE, which is forwarded by the re-establishment node.

In step 702, the source node determines a failure type based on the third LBT information, and/or the first RLF information. In step 703, the source node optimizes the LBT configuration.

In some embodiment, the source node optimizes the LBT configuration when a source cell quality at the time point that the RLF occurs in the source cell is higher than a second predefined threshold.

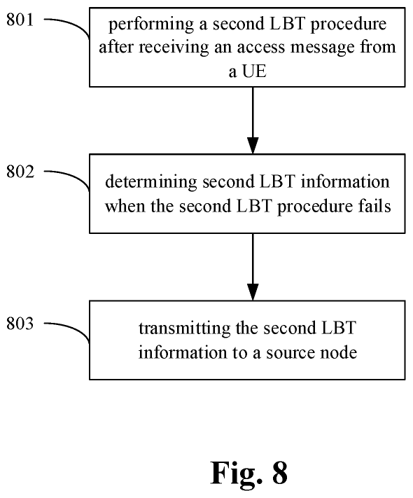

FIG. 8 illustrates a method performed by a target node for wireless communication according to an embodiment of the present disclosure.

In step 801, the target node performs a second LBT procedure after receiving the access message from the UE. In step 802, the target node determines the second LBT information when the second LBT procedure fails. In step 803, the target node transmits the second LBT information to a source node. For example, as shown in FIG. 3, the target node performs a LBT procedure in step 303, and determines the second LBT information, then transmits the second LBT information to the source node in step 305. The second LBT information is similar to those LBT information determined by the target node as illustrated in step 305 of FIG. 3.

The target node then may optimize the LBT configuration. Alternatively, the target node may optimize the LBT configuration when a target cell quality is higher than a threshold when the second LBT procedure fails.

The target node may receive a first message for optimizing LBT configuration from the source node. The target node may receive a second message for optimizing mobility configuration from the source node.

After receiving the first message, the target node may optimize the LBT configuration.

After receiving the second message, the target node may optimize the mobility configuration.

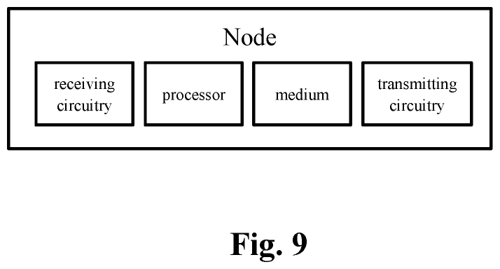

FIG. 9 illustrates a block diagram of a node according to some embodiments of the present disclosure.

The node may include a receiving circuitry, a processor, and a transmitting circuitry. In one embodiment, the node may include at least one non-transitory computer-readable medium having computer executable instructions stored therein. The processor can be coupled to the at least one non-transitory computer-readable medium, the receiving circuitry and the transmitting circuitry. The computer executable instructions can be programmed to implement a method with the receiving circuitry, the transmitting circuitry and the processor. The method implemented by the node of FIG. 9 can be any one of the methods shown in FIGS. 5-8.

The method of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While the present disclosure has been described with specific embodiments thereof, it is evident that many alternatives, modifications, and variations will be apparent to those skilled in the art. For example, various components of the embodiments may be interchanged, added, or substituted in other embodiments. Also, all of the elements shown in each FIG. are not necessary for operation of the disclosed embodiments. For example, one skilled in the art of the disclosed embodiments would be capable of making and using the teachings of the present disclosure by simply employing the elements of the independent claims. Accordingly, the embodiments of the present disclosure as set forth herein are intended to be illustrative, not limiting. Various changes may be made without departing from the spirit and scope of the present disclosure.

In this disclosure, relational terms such as “first,” “second,” and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An clement proceeded by “a,” “an,” or the like does not, without more constraints, preclude the existence of additional identical elements in the process, method, article, or apparatus that comprises the clement. Also, the term “another” is defined as at least a second or more. The terms “including,” “having,” and the like, as used herein, are defined as “comprising.”

1. A user equipment (UE), comprising:
a processor; and
a transceiver coupled to the processor, wherein the processor is configured to:
determining determine first listen before talk (LBT) information and/or first handover failure (HOF) information when a HOF occurs; and
transmit the first LBT information and/or the first HOF information to a serving node of the UE.

2. The UE of claim 1, wherein the processor is further configured to cause the UE to:
store the first HOF information if a first measurement result associated with a target cell when a first timer expires is lower than a first predefined value, and/or a second measurement result associated with a source cell when the first timer expires is higher than a second predefined value; and
store the first HOF information if the first measurement result is higher than the first predefined value, and/or the second measurement result is lower than the second predefined value.

3. The UE of claim 1, wherein the first LBT information includes at least one of the following:
a cause for the HOF;
a total number of a first type of LBT failure indicated by a first indication when a first timer is running;
a total number of uplink (UL) bandwidth parts (BWP) in the target cell associated with a LBT failure detection and recovery procedure when the first timer is running;
a second indication;
a time point of when the second indication is triggered;
a maximum value of the first type of LBT failure for each BWP;
a maximum value of a second timer associated with a second type of LBT failure for each BWP;
one or more physical random access channel (PRACH) occasions for each BWP;
a first time period in the UE for the LBT failure detection and recovery procedure in each BWP of the target cell;
a second time period from a time point when the handover procedure is initialized to a time point when the second indication is received;
a third time period from a time point when the second indication is received to a time point when the handover procedure fails;
a third measurement result associated with the target cell when a second type of LBT failure occurs in a BWP in the target cell;
a fourth measurement result associated with a target cell when a third type of LBT failure occurs;
a fifth measurement result associated with a source cell when the second type of LBT failure occurs in a BWP in the source cell; and
a sixth measurement result associated with the source cell when the third type of LBT failure occurs.

4. The UE of claim 1, wherein the first LBT information and the first HOF information are transmitted in a same message or in different messages.

5. The UE of claim 1, wherein the processor is further configured to cause the UE to:
optimize an LBT configuration.

6. A source node, comprising:
a processor; and
a transceiver coupled to the processor, wherein the processor is configured to:
receive first listen before talk (LBT) information and/or first handover failure (HOF) information from a user equipment (UE) or from a serving node, and/or
receive second LBT information from a target node and/or second HOF information from a serving node.

7. The source node of claim 6, wherein the processor is further configured to:
determine a failure type based on the first LBT information and/or the first HOF information. or
determine a failure type based on the second LBT information and/or the second HOF information,
wherein the failure type is an inappropriate mobility configuration and/or an inappropriate LBT configuration.

8. The source node of claim 6, wherein the processor is further configured to cause the source node to:
transmit a first message to the target node for optimizing LBT configuration when the failure type is the inappropriate LBT configuration.

9. The source node of claim 6, wherein the first LBT information includes at least one of the following:
a cause for the HOF;
a total number of a first type of LBT failure indicated by a first indication when a first timer is running;
a total number of uplink (UL) bandwidth parts (BWP) in the target cell associated with a LBT failure detection and recovery procedure when the first timer is running;
a second indication;
a time point of when the second indication is triggered;
a maximum value of the first type of LBT failure for each BWP;
a maximum value of a second timer associated with a second type of LBT failure for each BWP;
one or more physical random access channel (PRACH) occasions for each BWP;
a first time period in the UE for the LBT failure detection and recovery procedure in each UL BWP of the target cell;
a second time period from a time point when the handover procedure is initialized to a time point when the second indication is received;
a third time period from a time point when the second indication is received to a time point when the handover procedure fails;
a third measurement result associated with the target cell when a second type of LBT failure occurs in a BWP in the target cell;
a fourth measurement result associated with a target cell when a third type of LBT failure occurs;
a fifth measurement result associated with a source cell when the second type of LBT failure occurs in a BWP in the source cell; and
a sixth measurement result associated with the source cell when the third type of LBT failure occurs.

10. The source node of claim 6, wherein the second LBT information is a message that indicates that an LBT related failure occurred in the target node, or the second LBT information includes at least one of the following:
a cause for the HOF;
a first indication;
a second indication;
a number of a first type of LBT failure indicated by the first indication for a downlink (DL) bandwidth part (BWP) since receiving an access message from the UE;
a total number of the first indication since receiving the access message from the UE;
a total number of DL BWPs associated with a LBT failure detection and recovery procedure in the target cell since receiving the access message from the UE;
a time point of when the first indication or the second indication is triggered;
a maximum value of the first type of LBT failure for each BWP;
a maximum value of a second timer associated with a second type of LBT failure for each BWP;
one or more physical random access channel (PRACH) occasions for each BWP; and
a first time period for the LBT failure detection and recovery procedure in each BWP of the target cell.

11. A a target node, comprising:
a processor; and
a transceiver coupled to the processor, wherein the processor is configured to:
determine second listen before tak (LBT) information when the second LBT procedure fails; and
transmit the second LBT information to a source node.

12. The target node of claim 11, wherein the processor is further configured to cause the target node to:
optimize an LBT configuration.

13. The target node of claim 11, wherein the processor is further configured to cause the target node to:
optimize an LBT configuration when a target cell quality is higher than a threshold when the second LBT procedure fails.

14. The target node of claim 11, wherein the processor is further configured to cause the target node to:
receive a first message for optimizing LBT configuration from the source node.

15. The target node of claim 11, wherein the second LBT information is a message that indicates that an LBT related failure occurred in the target node, or the second LBT information includes at least one of the following:
a cause for the HOF;
a first indication;
a second indication;
a number of a first type of LBT failure indicated by a first indication for a downlink (DL) bandwidth part (BWP) since receiving an access message from the UE;
a total number of the first indication since receiving the access message from the UE;
a total number of DL BWPs associated with a LBT failure detection and recovery procedure in the target cell since receiving the access message from the UE;
a time point of when the first indication or the second indication is triggered;
a maximum value of the first type of LBT failure for each BWP;
a maximum value of a second timer associated with a second type of LBT failure for each BWP;
one or more physical random access channel (PRACH) occasions for each DL BWP; and
a first time period for the LBT type of failure detection and recovery procedure in each DL BWP of the target cell.

16. A processor for wireless communication, comprising:
at least one memory; and
a controller coupled with the at least one memory and configured to cause the processor to:
perform a first listen before talk (LBT) procedure before transmitting an access message for a handover procedure;
determine first LBT information and/or first handover failure (HOF) information when a HOF occurs; and
transmit the first LBT information and/or the first HOF information to a serving node of the UE.

17. The processor of claim 16, wherein the processor is further configured to:
store the first HOF information if a first measurement result associated with a target cell when a first timer expires is lower than a first predefined value, and/or a second measurement result associated with a source cell when the first timer expires is higher than a second predefined value; and
not store the first HOF information if the first measurement result is higher than the first predefined value, and/or the second measurement result is lower than the second predefined value.

18. The processor of claim 16, wherein the first LBT information includes at least one of the following:
a cause for the HOF;
a total number of a first type of LBT failure indicated by a first indication when a first timer is running;
a total number of uplink (UL) bandwidth parts (BWP) in the target cell associated with a LBT failure detection and recovery procedure when the first timer is running;
a second indication;
a time point of when the second indication is triggered;
a maximum value of the first type of LBT failure for each BWP;
a maximum value of a second timer associated with a second type of LBT failure for each BWP;
one or more physical random access channel (PRACH) occasions for each BWP;
a first time period in the UE for the LBT failure detection and recovery procedure in each BWP of the target cell;
a second time period from a time point when the handover procedure is initialized to a time point when the second indication is received;
a third time period from a time point when the second indication is received to a time point when the handover procedure fails;
a third measurement result associated with the target cell when a second type of LBT failure occurs in a BWP in the target cell;
a fourth measurement result associated with a target cell when a third type of LBT failure occurs;
a fifth measurement result associated with a source cell when the second type of LBT failure occurs in a BWP in the source cell; and
a sixth measurement result associated with the source cell when the third type of LBT failure occurs.

19. The processor of claim 16, wherein the first LBT information and the first HOF information are transmitted in a same message or in different messages.

20. The processor of claim 16, wherein the processor is further configured to:
optimize an LBT configuration.
